(19) United States
(12) Patent Application Publication
(10) Pub. No.: US 2026/0235166 A1
(43) Pub. Date: Aug. 13, 2026

(54) MULTIPOD JOINT

(71) Applicant: GKN Driveline Zumaia SA, Zumaia (ES)

(72) Inventors: Jesús Abenójar García-Minguillán, Zumaia (ES); Patricia Urbistondo, Zumaia (ES); Andoni Epelde, Zumaia (ES)

(21) Appl. No.: 19/531,807

(22) Filed: Feb. 6, 2026

(30) Foreign Application Priority Data
Feb. 7, 2025 (DE) 102025104642.5

(51) Int. Cl. F16D 3/205; F16D 3/202

(52) U.S. Cl. CPC F16D 3/2055; F16D 2003/2026

(57) ABSTRACT

A multipod joint with an outer joint part with a first longitudinal axis and a cavity running parallel to the first longitudinal axis with an open end, wherein at least two recesses, extending parallel to the first longitudinal axis, are distributed in the outer joint part along a first circumferential direction which extends around the first longitudinal axis, and an inner joint part with a second longitudinal axis, comprising at least one central body to which at least two trunnions are formed with trunnion axes extending radially from the second longitudinal axis, wherein a roller body rotatable at least about the trunnion axis is arranged on each trunnion; wherein each roller body is received in one of the recesses movably along the first longitudinal axis.

### CROSS REFERENCE TO RELATED APPLICATIONS

This application claims the priority to German Patent Application No. DE102025104642.5 filed on Feb. 7, 2025, and the content of this priority application is incorporated herein by reference in its entirety.

### TECHNICAL FIELD

The present disclosure relates to a multipod joint with an outer joint part and an inner joint part with a central body which comprises at least two trunnions connected to it. A roller body is arranged on each of the trunnions. In addition, the disclosure relates to a roller body for such a multipod joint.

### BACKGROUND

The multipod joint is, in particular, a bipod joint with exactly two trunnions, which are then offset by 180 degrees, i.e., arranged on the central body opposite each other. Alternatively, the multipod joint is a tripod joint with exactly three trunnions, which are then arranged on the central body in particular offset from each other by 120 angular degrees along the circumferential direction (around the second longitudinal axis). The following explanations apply in particular to all such joint types, taking into account the different number of trunnions.

Tripod joints of this type regularly comprise, for example, an outer joint part with a first longitudinal axis and a cavity running parallel to the first longitudinal axis with an open end, wherein three recesses running parallel to the first longitudinal axis are formed in the outer joint part. The tripod joint further comprises a joint inner part with a second longitudinal axis, comprising at least one central body on which three trunnions are formed with trunnion axes extending radially from the second longitudinal axis. A roller body is arranged on each trunnion, which has at least one outer ring and an inner ring that can be rotated relative to it about a common axis of rotation, as well as bearing bodies arranged between the outer ring and the inner ring. Each roller body is received in a respective recess movably along the first longitudinal axis.

The inner joint part can be inserted into the cavity of the outer joint part via the open end for mounting the multipod joint with the trunnions and roller bodies arranged thereon.

The central body can itself form a shaft or be connected to a shaft, e.g., via a spline toothing.

The inner joint part can be displaced along the first longitudinal axis relative to the outer joint part and can be deflected by a deflection angle relative to the outer joint part. The deflection angle is the smallest angle between the first and second longitudinal axes. When the joint is extended, the deflection angle is zero angular degrees. When the joint is deflected, the deflection angle is greater than zero angular degrees.

Tripod joints have been manufactured and sold by the applicant for some time, for example under the name AAR tripod joints. They are used in particular in side shafts of motor vehicles, which serve, for example, as the drive connection between a differential gear and the drive wheels. In this case, so-called fixed constant velocity ball joints are usually used on the wheel side and the AAR tripod joints listed here are used as sliding joints on the differential gear. The AAR tripod joints are designed in particular for deflection angles in the range of up to 23 degrees to 26 degrees (or less).

In a subtype of the AAR tripod joint, the AARi tripod joint, the inner ring is formed cylindrical towards the trunnion and the inner ring is fixed to the outer ring with regard to the direction along the axis of rotation by retaining rings.

The trunnion contacts the bearing body or the inner ring of the roller body via so-called sliding surfaces (contact surfaces), which are designed in particular as spherical segments. These sliding surfaces are aligned in a circumferential direction, which extends around the second longitudinal axis, so that a torque acting around the longitudinal axes of the joint, i.e., in a circumferential direction around the first longitudinal axis, is transmitted via the sliding surfaces of the trunnion to the roller body and from the roller body to the recesses (or vice versa).

A roller body rolls along designated raceways and can thus be displaced in the recess along the first longitudinal axis. Each recess thus has two opposing raceways by which the roller body can be supported with regard to a circumferential direction extending around the first longitudinal axis. Between these raceways of a recess, contact surfaces may be provided on which the roller body can be supported if necessary.

During the operation of a motor vehicle, different conditions can occur, for example, on a side shaft that extends essentially parallel to an axle of a motor vehicle and via which a wheel can be driven by a drive unit. In pull mode, the wheel is driven by the drive unit. In push mode, the motor vehicle is towed by the momentum of the motor vehicle. For a tripod joint arranged on the side shaft, the contacts between the trunnions and the roller bodies or between the roller bodies and the recesses differ in certain conditions.

If the motor vehicle is traveling forward, for example, the direction of rotation of the side shaft is constant. When switching between push mode and pull mode, the contacts between the sliding surfaces of the trunnion and the roller body or between the roller body and the recesses change (i.e., from one side to the other), e.g., viewed in a cross-section extending transverse to the first longitudinal axis and/or the second longitudinal axis. Even when the motor vehicle changes its direction of travel (from forward to reverse), the contact between the trunnion and the roller body or between the roller body and the recess changes to the other side of the trunnion or recess when viewed in the circumferential direction.

In principle, the side of the sliding surfaces or recesses on which the contacts (transmitting torque) are present is referred to as the “active side” and the other side of the sliding surfaces or recesses on which the contacts are not present is referred to as the “passive side.”

When a motor vehicle is in pull mode, i.e., when the motor vehicle is driven by a drive unit, the trunnion contacts one of the sliding surfaces of the roller body and the roller body contacts one side of the recesses (active side) in particular. During push mode or in coast mode (both referred to as coasting) of the motor vehicle, i.e. when drive torques are introduced from the wheel and the drive unit is still connected (push mode) or disconnected (coast mode), the trunnion contacts the roller body with the other of the sliding surfaces and the roller body contacts the other side of the recesses in particular (active side). In push mode or coast mode, the direction of the applied torques and the direction of rotation of the joint are opposite to each other, while in pull mode they are in the same direction.

The properties of a multipod joint are also defined in particular by a so-called ACFG value (Axial Cyclic Force Generation, unwanted axial forces generated by the joint). This value is given as the square mean value of the force, with the unit Newton root mean square [Nrms]. The value varies depending on the deflection angle of the joint, whereby the course of the value can be defined or determined for each joint depending on the deflection angle. The range of application of the joint is thus limited by a maximum deflection angle at which the ACFG value does not exceed an absolute value that is still considered acceptable.

In addition, with multipod joints, movement of the roller body during joint operation must be controlled. For example, the roller body may also contact the recess on the passive side, particularly when the joint is operated at a deflection angle greater than zero degrees. This contact can generate noise on the one hand, but also friction losses on the other, whereby abrasion can also occur on the roller body and/or on the recess, which actually limits the service life of the joint.

To control the movement of the roller body, it is known, for example, that the contact surfaces described above can be provided in the recesses, i.e., along the circumferential direction between the raceways of a recess. This can limit tilting of the roller body (about a so-called tilt or pitch axis). However, contact between the contact surface and the roller body also generates noise and friction losses. Tilting of the roller body about a so-called roll axis, which extends transversely to an extension of the respective recess, should also be controlled, because this can cause contact between the roller body and the raceway or recess on the passive side.

A tripod joint is known, for example, from DE 10 2023 117 277 A1.

The present disclosure is based on the task of at least partially solving the problems described with reference to the prior art. In particular, a multipod joint or roller body is to be proposed by means of which the ACFG forces can be further reduced.

### SUMMARY

These tasks are solved with a multipod joint. Further advantageous embodiments are specified in the dependent claims. It should be noted that the features listed individually in the dependent claims can be combined with each other in any technologically sensible way and define further embodiments of the disclosure. In addition, the features specified in the claims are further specified and explained in the description, whereby further preferred embodiments of the disclosure are presented.

A multipod joint is proposed,
with an outer joint part with a first longitudinal axis and a cavity running parallel to the first longitudinal axis with an open end, wherein at least two recesses running parallel to the first longitudinal axis are (evenly) distributed in the outer joint part along a first circumferential direction extending around the first longitudinal axis, and
with an inner joint part with a second longitudinal axis, comprising at least one central body to which at least two trunnions are formed with trunnion axes extending radially (along a radial direction) from the second longitudinal axis,
wherein a roller body rotatable at least about the trunnion axis is arranged on each trunnion.

Each roller body is movably received in one of the recesses along the first longitudinal axis. Each roller body has
an axis of rotation,
an outer ring,
an inner ring arranged concentrically to the outer ring and to the axis of rotation, and
a plurality of rolling elements (in particular needle-shaped) between the outer ring and the inner ring.

The rolling elements are arranged side by side along a second circumferential direction in a receiving space of the outer ring, wherein the receiving space extends circumferentially along the second circumferential direction, so that the inner ring can rotate relative to the outer ring about the axis of rotation. The inner ring is displaceable relative to the outer ring and the rolling elements along the axis of rotation. The outer ring forms a first stop with the inner ring. at a first end face of the roller body pointing away from the second longitudinal axis, which limits a first displacement path of the inner ring relative to the outer ring. The first displacement path extends along a first direction being parallel to the axis of rotation and extending away from the second longitudinal axis. The inner ring forms a second stop with the trunnion, which limits a second displacement path of the inner ring relative to the trunnion. The second displacement path extends along a second direction being parallel to the axis of rotation and extending towards the second longitudinal axis. The multipod joint is designed in such a way that, within an intended operating range (also referred to as intended use) of the multipod joint, contact between the inner ring and the outer ring (or with a retaining ring arranged on the outer ring) is prevented on a second end face of the roller body facing the second longitudinal axis, or only the inner ring contacts the central body.

In the context of the present disclosure, it was recognized that contact between an outer ring and an inner ring of the roller body can occur at larger deflection angles. This is precisely what generates undesirable axial forces.

The roller body comprises, in particular, an outer ring and an inner ring, which can rotate relative to each other. In addition, bearing bodies (rolling bodies/elements, e.g., needle-shaped rolling elements) are arranged between the inner ring and the outer ring. These bearing elements (in particular cylindrical ones) are arranged in a receiving space in the outer ring. A plurality of these bearing elements are arranged along the circumferential direction around the axis of rotation. The bearing elements are secured against displacement along the axis of rotation, in particular by means of retaining rings arranged in a respective groove on the outer ring.

The rotation of the inner ring relative to the outer ring allows the roller body to roll along the recesses or raceways in the outer joint part, so that the inner joint part can be displaced along the first longitudinal axis relative to the outer joint part.

When the inner joint part is deflected relative to the outer joint part, the roller bodies continue to be guided through the recesses/raceways, whereby at least the trunnions are pivoted relative to the roller bodies.

In particular, the roller bodies are guided by the recesses in such a way that pivoting of the roller bodies relative to the recesses is not possible or is restricted as far as possible.

Alternatively, when the inner part of the joint is deflected, the roller bodies are also pivoted relative to the recesses. During this pivoting, the roller bodies are supported by a contact surface on the outer part of the joint. This contact surface is arranged along the first circumferential direction between the respective recesses.

For example, if the outer ring of the roller body has a spherical outer contour on its outer circumferential surface, the outer ring can be pivotable or swivelable about a central axis of the recess of the outer joint part. The recess in the outer joint part is shaped accordingly so that the roller body is not fixed in the first circumferential direction of the outer joint part, but can be pivoted in a range of in particular 0 to 5 angular degrees, in particular 0 to 3 angular degrees, on both sides relative to the center axis of the recess. This pivoting is referred to as orbital movement or orbital angle. The center axis of the path is the axis of each recess in the outer joint part along which the roller bodies can move as a result of the axial forces in the outer joint part.

In this case, the angular compensation of the orbital movement can also take place at least partially between the trunnion and the inner ring. For this purpose, the circumferential surface of the trunnion must be convexly curved. The convex shape of this surface means that the surface is designed in accordance with a spherical segment, a barrel segment, a toroidal segment, or a cylindrical segment.

In addition to the relative rotation, the inner ring and the outer ring can also (only) perform a relative displacement along the common axis of rotation relative to each other. For example, a displacement of the inner ring relative to the outer ring towards the second longitudinal axis can be limited by a retaining ring (arranged on the outer ring); alternatively, no limitation is provided. In particular, displacement of the inner ring relative to the outer ring away from the second longitudinal axis is limited by a retaining ring (arranged on the outer ring).

In particular, the outer ring forms (exactly or only) a first stop with the inner ring, which limits displacement of the inner ring relative to the outer ring along the axis of rotation and away from the second longitudinal axis. In particular, this first stop is formed by a projection formed on the outer ring or a retaining ring arranged on the outer ring, against which the inner ring abuts when the inner ring has been displaced to its maximum extent. The inner ring can therefore only be displaced along this first direction, i.e. along the axis of rotation and away from the second longitudinal axis, until it contacts the stop surfaces.

The inner ring forms a second stop with the trunnion, which limits a second displacement path of the inner ring relative to the trunnion. The second displacement path extends along the second direction running parallel to the axis of rotation and towards the second longitudinal axis. The second stop is formed in particular by a retaining ring (on the inner ring or on the trunnion) or by a section of the inner ring with a reduced inner diameter.

The multipod joint is designed in particular such that, in an intended operating range of the multipod joint, contact between the inner ring and the outer ring (or with a retaining ring arranged on the outer ring) is not possible/excluded on a second end face of the roller body facing the second longitudinal axis, or only the inner ring contacts the central body. In particular, the multipod joint is designed in such a way that, in an intended operating range, contact between the inner ring and the outer ring (at the second end face) is not possible and that only the inner ring (and not the outer ring) contacts the central body.

At least when the axis of rotation and the trunnion axis are coaxial, the inner ring forms (precisely or only) one second stop with the trunnion. The second stop limits displacement of the inner ring along the trunnion axis toward the second longitudinal axis. In the intended operation, i.e., when the inner joint part and the outer joint part are arranged together to form the multipod joint, the displacement of the inner ring relative to the trunnion along the trunnion axis away from the second longitudinal axis is unrestricted, i.e., limited only by the first stop. In particular, the outer ring is supported by the recesses, so that the first stop then prevents further displacement of the inner joint part.

The first stop can limit displacement of the inner ring in coast mode (push-and sail mode) in particular.

The second stop can be used in particular to control displacement of the inner ring during pull mode.

The first stop is arranged along the axis of rotation on a second end face of the roller body pointing away from the second longitudinal axis. The first stop is formed in particular by a projection of the outer ring, which extends inward along a radial direction toward the axis of rotation and thereby extends at least partially over the inner ring.

In particular, the first stop is formed by the outer ring itself or by a retaining ring arranged on the outer ring. The retaining ring can be designed, for example, in the manner of a so-called snap ring. The retaining ring can be arranged in a circumferential groove on the outer ring and protrude from the groove so that the retaining ring contacts the inner ring when it is displaced sufficiently far along the axis of rotation and away from the second longitudinal axis.

A retaining ring and/or the groove required for it requires additional installation space, so that the roller body may have to be larger. On the other hand, the outer ring can be manufactured more cost-effectively if a retaining ring is provided instead of a projection formed on the outer ring.

In particular, the receiving space for the rolling elements on the outer ring is limited by a retaining ring arranged on the outer ring. In particular, the receiving space is limited on only one side of the rolling elements by a retaining ring, while on the other side (towards the second longitudinal axis) the receiving space is limited by the outer ring itself.

The intended operation (intended operating range) of the multipod joint includes, in particular, the inner joint part and the outer joint part being arranged relative to each other as intended for the specific application. For example, all rolling bodies are arranged in the recesses and the joint is only operated within a specific range of the deflection angle, e.g., between zero and 20 angular degrees or between zero and 18 angular degrees. Furthermore, the torques considered permissible for the joint are transmitted between the outer joint part and the inner joint part, and displacement of the roller bodies along the first longitudinal axis only occurs to a certain extent.

Improper operation (unintended operating range) includes, for example, the assembly of the joint or the assembly of joint parts, e.g., the arrangement of the roller bodies on the trunnions.

In the intended operation, the inner ring contacts the trunnion in particular via a cylindrical sliding surface (contact surface) on the inner ring (additionally via the second stop, if applicable). In particular, the trunnion has a spherical or otherwise curved sliding surface (contact surface). However, other pairings of the sliding surfaces are also possible.

The recesses (running surfaces) for the roller bodies are gothic in shape in a cross-section running transversely to the first longitudinal axis. The gothic shape of recesses is generally known. This shape is formed, for example, by two radii, each of which is offset from the center axis of the recess. A spherically shaped outer ring would therefore always contact this Gothic-shaped recess at two contact points.

In particular, each roller body is supported via a plurality of contact points on (only) one of the two raceways (i.e., on the so-called active side). Preferably, (exactly) two contact points are provided.

In particular, the inner ring has a cut-out on the second end face extending circumferentially along the second circumferential direction. An outer circumferential surface of the inner ring contacting the rolling elements is shortened and an end face (of the inner ring) pointing towards the second longitudinal axis is reduced in size by the cut-out. In particular, this cut-out removes an edge of the inner ring.

This cut-out makes it possible, in particular, for the inner ring to be designed wider in a direction along the axis of rotation. This ensures permanent contact between the sliding surfaces of the inner ring and the trunnion. In addition, the cut-out is designed in such a way that a retaining ring or a projection on the outer ring (in the area of the second end face of the roller body) is not contacted by the inner ring.

In particular, the outer ring has a smallest first diameter on the second end face, which is smaller than a second diameter of the outer circumferential surface (of the inner ring) and larger than a smallest third diameter of the cut-out. In particular, the outer ring is designed in such a way that the inner ring cannot be inserted into the outer ring via this smallest first diameter.

In particular, the outer ring has on the second end face (of the roller body or the outer ring) a third stop that is effective for the rolling elements (in the receiving space) with regard to the second direction, and a fourth stop that is effective for the inner ring (e.g., in the form of the smallest first diameter) with regard to the second direction.

In particular, in an extended state of the multipod joint (deflection angle is zero angular degrees, first and second longitudinal axes are coaxial with each other), the fourth stop is spaced along the second direction at a distance Ds from the cut-out, where Ds is given by: Ds>¾*PCD1*cos(1/α) ; where PCD1 is the pitch circle diameter of the inner joint part and α is the largest deflection angle between the first longitudinal axis and the second longitudinal axis occurring in the intended operating range.

The distance Ds is, in particular, the distance between the stop surfaces of the inner ring and outer ring arranged opposite each other along the axis of rotation (or the first and/or second direction). The distance Ds ensures that no contact occurs between the inner ring and the outer ring during the intended operation.

The size of the distance Ds is limited in particular so that the outer ring does not contact the inner joint part during the intended operation.

In particular, at least the third stop or the fourth stop is formed by the outer ring itself, preferably both stops are formed by the outer ring itself. Alternatively, at least one of the stops can be formed by a retaining ring.

In particular, in an extended state of the multipod joint, a PCD2 (pitch circle diameter) of the outer joint part is greater than a PCD1 of the inner joint part by a difference D, whereby the following applies to the difference: D≥¼*PCD2*cos(1/α); where α is the maximum deflection angle between the first longitudinal axis and the second longitudinal axis that occurs during the intended operation. In particular, this condition always applies during the intended operation, i.e., the PCD 2 is greater than the PCD 1 at every deflection angle (up to the predetermined maximum deflection angle).

The pitch circle diameter PCD1 of the trunnions or the inner joint part is the so-called effective diameter. This is defined for an extended joint, i.e., the longitudinal axes are coaxial with each other. The effective radius/diameter defines the lever arm of the resultant force when transmitting a torque. The pitch circle radius of the trunnions or the inner part of the joint (PCD1/2) is therefore the radius, starting from the second longitudinal axis of the inner joint part, on which, for example, the centers of the spherical segment-shaped sliding surfaces of the trunnion are located when the joint is extended. The same applies to the pitch circle diameter PCD1, which corresponds to twice the pitch circle radius of the inner joint part.

The pitch circle radius (PCD2/2) of the outer joint part or the recesses is also the so-called effective radius, which is defined when the joint is extended, i.e., the longitudinal axes are coaxial with each other. The effective radius defines the lever arm of the resultant force when a torque is transmitted. The same applies here to the pitch circle diameter PCD2, which corresponds to twice the pitch circle radius of the outer joint part.

The definition of the pitch circle radius or diameter (also referred to as PCR or PCD) is generally known, especially for tripod joints.

In particular, the outer ring has a toroidal outer shape and the outer ring contacts the (particularly Gothic-shaped) recess at two contact points, whereby the contact points are spaced apart from each other in a radial direction.

In particular, the toroidal outer shape meets the following condition: 0.5≤2*Rs/Dr≤1; where Rs is the radius of curvature of the toroidal outer shape in the area of the contact points and Dr is the largest diameter of the outer ring.

In the toroidal outer shape, the outer shape of the outer ring (viewed in a cross-section lying in a plane with the axis of rotation) is formed in particular by two spherical segment-shaped surfaces with radius Rs, which are tangentially connected by a straight line (or line).

In particular, an intended operating range comprises a maximum deflection angle occurring between the first longitudinal axis and the second longitudinal axis of between 12 and 20 angular degrees, in particular of at least 15 angular degrees, preferably of at least 18 angular degrees. In this intended operating range of the multipod joint, contact between the inner ring and the outer ring (or with a retaining ring arranged on the outer ring) on a second end face of the roller body, facing the second longitudinal axis, is not possible, or only the inner ring contacts the central body. In particular, the multipod joint is designed in such a way that, in an intended operating range, contact between the inner ring and the outer ring (at the second end face) is not possible and only the inner ring (and not the outer ring) contacts the central body.

In particular, the first stop is formed by a retaining ring arranged on the outer ring.

In particular, the second stop is formed by a concavely curved or conically shaped first section of an inner circumferential surface of the inner ring, which adjoins a cylindrically shaped second section of the inner circumferential surface along the first direction, wherein a diameter of the inner circumferential surface in the first section is smaller than a diameter of the inner circumferential surface in the second section.

A roller body for the described multipod joint is also proposed. The roller body has an axis of rotation, an outer ring, an inner ring arranged concentrically to the outer ring and the axis of rotation, and a plurality of rolling elements between the outer ring and the inner ring, which are arranged side by side along a second circumferential direction in a receiving space of the outer ring extending circumferentially along the second circumferential direction, so that the inner ring can rotate relative to the outer ring about the axis of rotation. The inner ring can be displaced relative to the outer ring and the rolling elements along the axis of rotation. The outer ring forms a first stop with the inner ring at a first end face of the roller body, which points away from the second longitudinal axis, which first stop limits a first displacement path of the inner ring relative to the outer ring, wherein the first displacement path extends along a first direction parallel to the axis of rotation and away from the second longitudinal axis. The inner ring has a concave curved or conical shaped first section on an inner circumferential surface, which adjoins a cylindrical shaped second section of the inner circumferential surface along the first direction, wherein a diameter of the inner circumferential surface in the first section is smaller than a diameter of the inner circumferential surface in the second section. The inner ring has a cut-out on the second end face that extends circumferentially along the second circumferential direction. By the cut-out, an outer circumferential surface of the inner ring that contacts the rolling elements (with regard to the extension of the inner ring along the axis of rotation) is shortened and an end face facing the second longitudinal axis (with regard to an extension of the inner ring transverse to the axis of rotation) is reduced.

In particular, the outer ring has a smallest first diameter on the second end face, which is smaller than a second diameter of the outer circumferential surface and larger than a smallest third diameter of the cut-out.

In particular, the outer ring on the second end face has a third stop which is effective with regard to the second direction for the rolling elements, and a fourth stop which is effective with regard to the second direction for the inner ring.

In particular, the third stop and/or the fourth stop is formed by the outer ring itself.

The explanations relating to the multipod joint apply in the same way to the roller body and vice versa.

Furthermore, a motor vehicle is also claimed here that has at least one of the multipod joints described.

The use of indefinite articles (“a”, “an”), especially in the claims and the description reproducing them, is to be understood as such and not as a numeral. Accordingly, terms or components introduced in this way are to be understood as meaning that they are present at least once and, in particular, may also be present multiple times.

As a precaution, it should be noted that the numerals used here (“first,” “second,” etc.) serve primarily (only) to distinguish between several similar objects, sizes, or processes, i.e., in particular, they do not necessarily specify any dependency and/or sequence of these objects, sizes, or processes in relation to each other. If a dependency and/or sequence is required, this is explicitly stated here or is obvious to the skilled person when studying the specifically described design. Insofar as a component can occur multiple times (“at least one”), the description of one of these components may apply equally to all or some of the plurality of these components, but this is not mandatory.

### BRIEF DESCRIPTION OF THE DRAWINGS

The disclosure and the technical environment are explained in more detail below with reference to the accompanying figures. It should be noted that the disclosure is not intended to be limited by the examples given. In particular, it should be noted that the figures and, in particular, the proportions shown are only schematic. They show:

FIG. 1: a multipod joint designed as a tripod joint in the extended state, in a side view in section;

FIG. 2: the tripod joint according to FIG. 1 in a view along the longitudinal axes, in section;

FIG. 3: a detail of the tripod joint according to FIG. 2;

FIG. 4: a first diagram;

FIG. 5: a second diagram;

FIG. 6: the tripod joint according to FIGS. 1 to 3 in a deflected state, in a side view in section;

FIG. 7: the tripod joint according to FIG. 5 in a view along the first longitudinal axis, in section;

FIG. 8: the tripod joint according to FIGS. 1 to 3 and 5 to 6 in a different deflected state, in a side view in section; and

FIG. 9 the tripod joint according to FIG. 8 in a view along the first longitudinal axis, in section.

### DETAILED DESCRIPTION

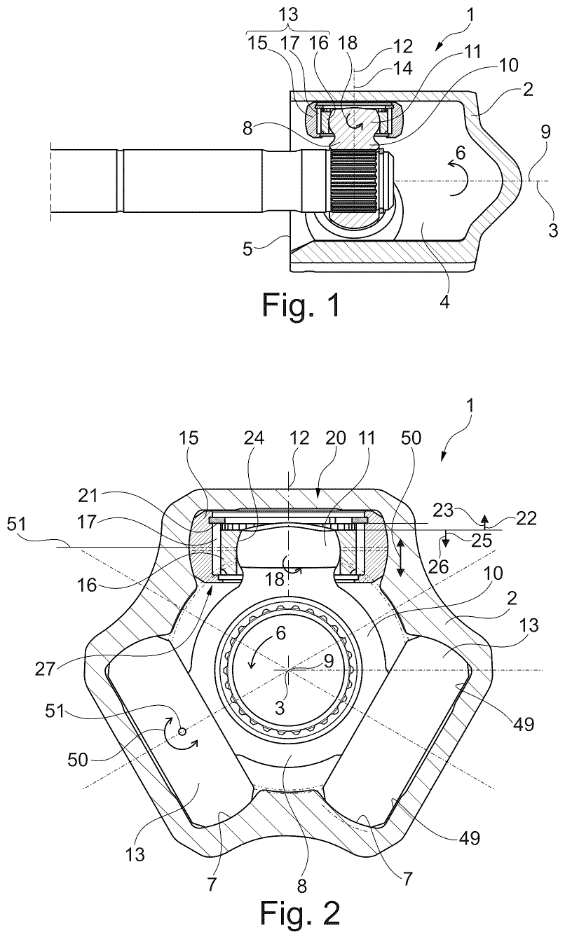

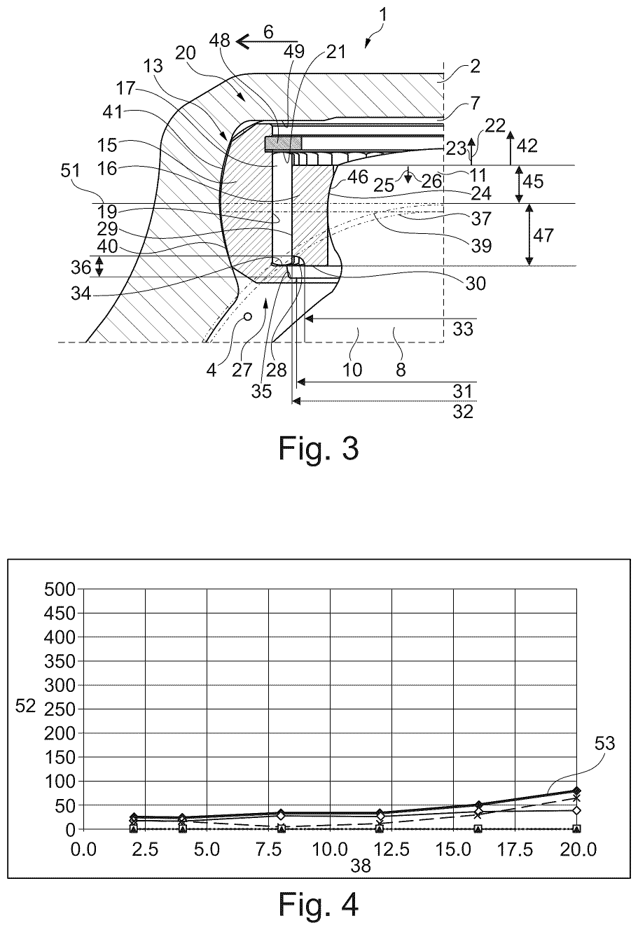

FIG. 1 shows a multipod joint 1 designed as a tripod joint 1 in an extended state, in a side view in section. FIG. 2 shows the tripod joint 1 according to FIG. 1 in a view along the longitudinal axes 3, 9, in section. FIG. 3 shows a detail of the tripod joint 1 according to FIG. 2. FIGS. 1 to 3 are described together below.

The tripod joint 1 comprises an outer joint part 2 with a first longitudinal axis 3 and a cavity 4 running parallel to the first longitudinal axis 3 with an open end 5. Three recesses 7 are provided in the outer joint part 2, each of which runs parallel to the first longitudinal axis 3 and which are evenly distributed along a first circumferential direction 6 extending around the first longitudinal axis 3. The tripod joint 1 further comprises an inner joint part 8 with a second longitudinal axis 9. The inner joint part 8 has a central body 10 on which three trunnions 11 are formed with trunnion axes 12 extending radially (along a radial direction) from the second longitudinal axis 9. A roller body 13 rotatable at least about the trunnion axis 12 is arranged on each trunnion 11.

Each roller body 13 is received in one of the recesses 7 movably along the first longitudinal axis 3. Each roller body 13 has a rotational axis 14, an outer ring 15, an inner ring 16 arranged concentrically to the outer ring 15 and the rotational axis 14, and a plurality of needle-shaped rolling elements 17 between the outer ring 15 and the inner ring 16.

The rolling elements 17 are arranged next to each other along a second circumferential direction 18 in a receiving space 19 of the outer ring 15, which is formed circumferentially along the second circumferential direction 18, so that the inner ring 16 can rotate relative to the outer ring 15 about the axis of rotation 14.

The inner ring 16 can be displaced relative to the outer ring 15 and the rolling elements 17 along the axis of rotation 14. The outer ring 15 forms a first stop 21 with the inner ring 16 at a first end face 20 of the roller body 13, pointing away from the second longitudinal axis 9, via a retaining ring 48, which limits a first displacement path 22 of the inner ring 16 relative to the outer ring 15. The first displacement path 22 extends along a first direction 23 which runs parallel to the axis of rotation 14 and away from the second longitudinal axis 9.

The inner ring 16 forms a second stop 24 with the trunnion 11, which limits a second displacement path 25 of the inner ring 16 relative to the trunnion 11. The second displacement path 25 extends along a second direction 26 which runs parallel to the axis of rotation 14 and towards the second longitudinal axis 9.

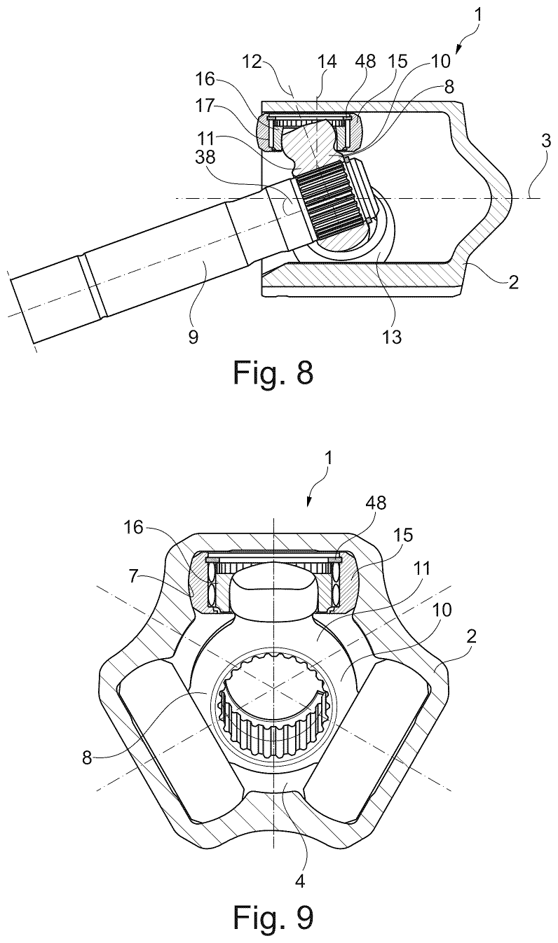

The tripod joint 1 is designed in such a way that, within an intended operating range (also referred to as intended use) of the tripod joint 1, contact between the inner ring 16 and the outer ring 15 is not possible/excluded at a second end face 27 of the roller body 13 facing the second longitudinal axis 9, or only the inner ring 16 contacts the central body 10 (the latter is the case in FIGS. 6 and 8).

The roller body 13 comprises the outer ring 15 and the inner ring 16, which can rotate relative to each other. The rotation of the inner ring 16 relative to the outer ring 15 allows the roller body 13 to roll along the recesses 7 or raceways in the outer joint part 2, so that the inner joint part 8 can be displaced along the first longitudinal axis 3 relative to the outer joint part 2.

When the inner joint part 8 is deflected relative to the outer joint part 2, the roller bodies 13 continue to be guided by the recesses 7/raceways, whereby at least the trunnions 11 are pivoted relative to the roller bodies 13 (see FIGS. 6 to 9). The roller bodies 13 are guided by the recesses 7 in such a way that any pivoting of the roller bodies 13 relative to the recesses 7 is restricted as far as possible.

During this pivoting, the roller bodies 13 are supported by a contact surface 49 on the outer joint part 2. This contact surface 49 is arranged along the first circumferential direction 6 between the respective recesses 7.

In addition to the relative rotation, the inner ring 16 and the outer ring 15 can also perform a relative displacement along the common axis of rotation 14 relative to each other. A displacement of the inner ring 16 relative to the outer ring 15 away from the second longitudinal axis 9 is limited by a retaining ring 48 arranged on the outer ring 15.

The outer ring 15 forms a first stop 21 with the inner ring 16, which limits the displacement of the inner ring 16 relative to the outer ring 15 along the axis of rotation 14 and away from the second longitudinal axis 9. This first stop 21 is formed by a retaining ring 48 arranged on the outer ring 15, which the inner ring 16 abuts when the inner ring 16 has been displaced to its maximum extent. The inner ring 16 can therefore only be displaced along this first direction 23, i.e. along the axis of rotation 14 and away from the second longitudinal axis 9, until the stop surfaces contact each other.

The inner ring 16 forms a second stop 24 with the trunnion 11, which limits a second displacement path 25 of the inner ring 16 relative to the trunnion 11. The second displacement path 25 extends along the second direction 26, which runs parallel to the axis of rotation 14 and towards the second longitudinal axis 9. The second stop 24 is formed by a first section 45 of the inner ring 16 having a reduced inner diameter.

The second stop 24 is formed by a concavely curved first section 45 of an inner circumferential surface 46 of the inner ring 16, which adjoins a cylindrically shaped second section 47 of the inner circumferential surface 46 along the first direction 23, wherein a diameter of the inner circumferential surface 46 in the first section 45 is smaller than a diameter of the inner circumferential surface 46 in the second section 47.

In the intended operation, i.e. when the inner joint part 8 and the outer joint part 2 are arranged together to form the tripod joint 1, the displacement 54 of the inner ring 16 relative to the trunnion 11 along the trunnion axis 12 away from the second longitudinal axis 9 is unrestricted, i.e. limited only by the first stop 21. The outer ring 15 is supported by the recesses 7, so that the first stop 21 then prevents further displacement 54 of the inner joint part 8.

The first stop 21 is formed by a retaining ring 48 arranged on the outer ring 15. The retaining ring 48 is designed as a snap ring. The retaining ring 48 is arranged in a circumferential groove (see FIG. 3) on the outer ring 15 and protrudes from the groove so that the retaining ring 48 contacts the inner ring 16 when the latter is displaced sufficiently far along the axis of rotation 14 and away from the second longitudinal axis 9.

The receiving space 19 for the rolling elements 17 on the outer ring 15 is limited by the retaining ring 48 arranged on the outer ring 15. The receiving space 19 is limited on only one side of the rolling elements 17 by a retaining ring 48, whereas on the other side (towards the second longitudinal axis 9) the receiving space 19 is limited by the outer ring 15 itself.

The recesses 7 (running surfaces) for the roller bodies 13 are Gothic in shape in a cross-section running transversely to the first longitudinal axis 3. The Gothic shape of recesses 7 is generally known. This shape is formed, for example, by two radii, each of which is offset from a central axis of the recess 7.

Each roller body 13 is supported relative to the first circumferential direction 6 via a plurality of contact points on only one of the two raceways (i.e., on the so-called active side of the recess 7).

The inner ring 16 has a cut-out 28 on the second end face 27 that extends circumferentially along the second circumferential direction 18. The cut-out 28 shortens an outer circumferential surface 29 of the inner ring 16 that contacts the rolling elements 17 and reduces an end face 30 of the inner ring 16 pointing toward the second longitudinal axis 9 in size. This cut-out 29 removes an edge of the inner ring 16.

This cut-out 28 allows the inner ring 16 to be made wider in a direction 23, 26 along the axis of rotation 14. This ensures permanent contact between the sliding surfaces of the inner ring 16 and the trunnion 11. In addition, the cut-out 28 is designed in such a way that a projection on the outer ring 15 in the area of the second end face 27 of the roller body 13 is not contacted by the inner ring 16.

The outer ring 15 has a smallest first diameter 31 on the second end face 27, which is smaller than a second diameter 32 of the outer circumferential surface 29 of the inner ring 16 and larger than a smallest third diameter 33 of the cut-out 28. The outer ring 15 is thus designed in such a way that the inner ring 16 cannot be inserted into the outer ring 15 via this smallest first diameter 31.

The outer ring 15 has on the second end face 27 (of the roller body 13 or the outer ring 15) a third stop 34 which is effective with regard to the second direction 26 for the rolling elements 17(in the receiving space 19), and a fourth stop 35 which is effective with regard to the second direction 26 for the inner ring 16. The fourth stop 35 is formed by the projection of the outer ring 15, which extends to the smallest first diameter 31.

The fourth stop 35 is spaced apart from the cut-out 28 along the second direction 26 at a distance Ds 36, where Ds 36 is defined as follows: Ds>¾*PCD1*cos(1/α); where PCD1 37 is the pitch circle diameter of the inner joint part 8 and α is the largest deflection angle 38 (see FIGS. 6 and 8) occurring in the intended operating range between the first longitudinal axis 3 and the second longitudinal axis 9.

The distance Ds 36 is the distance between the stop surfaces of the inner ring 16 and outer ring 15 that are arranged opposite each other along the axis of rotation 14. The distance Ds 36 ensures that there is no contact between the inner ring 16 and the outer ring 15 during the intended operation.

The size of the distance Ds 36 is limited so that the outer ring 15 does not contact the inner joint part 8 during the intended operation.

The third stop 34 and the fourth stop 35 are both formed by the outer ring 15 itself.

A PCD2 39 (pitch circle diameter) of the outer joint part 2 is greater than a PCD1 37 of the inner joint part 8 (see FIG. 3) by a difference D, where the following applies to the difference D: D≥¼*PCD2*cos(1/α); where α is the maximum deflection angle 38 between the first longitudinal axis 3 and the second longitudinal axis 9 that occurs during the intended operation. This condition always applies during the intended operation, i.e., at all times.

The pitch circle diameter PCD1 37 of the trunnions 11 or the inner joint part 8 is the so-called effective diameter. This is defined for an extended tripod joint 1, i.e. the longitudinal axes 3, 9 are arranged coaxially to each other (see FIGS. 1 to 3). The effective radius/diameter defines the lever arm of the resultant force when a torque is transmitted. The pitch circle radius of the trunnions 11 or the inner joint part 8 (PCD1/2) is therefore the radius, starting from the second longitudinal axis 9 of the inner joint part 8, on which, for example, the centers of the spherical segment-shaped sliding surfaces of the trunnion 11 are arranged when the tripod joint 1 is extended. The same applies to the pitch circle diameter PCD1 37, which corresponds to twice the pitch circle radius of the inner joint part 8.

The pitch circle diameter (PCD2/2) of the outer joint part 2 or the recesses 7 is also the so-called effective radius, which is defined for an extended tripod joint, i.e., the longitudinal axes 3, 9 are arranged coaxially to each other. The effective radius defines the lever arm of the resultant force when a torque is transmitted. The same applies here to the pitch circle diameter PCD2 39, which corresponds to twice the pitch circle radius of the outer joint part 2.

The outer ring 15 has a toroidal outer shape and the outer ring 15 contacts the Gothic-shaped recess 7 at two contact points 40, 41, whereby the contact points 40, 41 are spaced apart from each other in a radial direction 42.

The toroidal outer shape satisfies the following condition: 0.5≤2*Rs/Dr≤1; where Rs 43 is the radius of curvature of the toroidal outer shape in the area of the contact points 40, 41 and Dr 44 is the largest diameter of the outer ring (see FIG. 3).

In the toroidal outer shape, the outer shape of the outer ring 15 (viewed in a cross-section lying in a plane with the axis of rotation 14, see FIG. 3) is formed by two spherical segment-shaped surfaces with radius Rs 43, which are tangentially connected by a straight line (the straight line connects tangentially to the spherical segment-shaped surface sections and connects them).

The outer ring 15 of the roller body 13 has a toroidal outer contour, whereby the outer ring 15 can be pivoted or swiveled about a central axis 51 of the recess 7 of the outer joint part 2. The recess 7 in the outer joint part 2 is shaped accordingly so that the roller body 13 is not fixed but can be pivoted on both sides relative to the center axis 51 of the recess 7. This pivoting is referred to as orbital movement 50 or orbital angle (see FIG. 2). The center axis 51 is the axis of each recess 7 in the outer joint part 2, along which the roller bodies 13 can move as a result of the axial forces 52 in the outer joint part 2.

In this case, the angular compensation of the orbital movement 50 can also take place at least partially between trunnion 11 and inner ring 16. For this purpose, the circumferential surface of trunnion 11 is designed with a convex curvature.

FIG. 4 shows a first diagram. The axial force 52 or the ACFG value (Axial Cyclic Force Generation; with the unit Newton root mean square [Nrms]) is plotted on the vertical axis. The deflection angle 38 (in angular degrees) is plotted on the horizontal axis. Reference is made to the explanations for FIGS. 1 to 3.

The first course 53 shows the ACFG values occurring at certain deflection angles 38. Up to a deflection angle 38 of 20 angular degrees, very low ACFG values can be achieved with the proposed tripod joint 1.

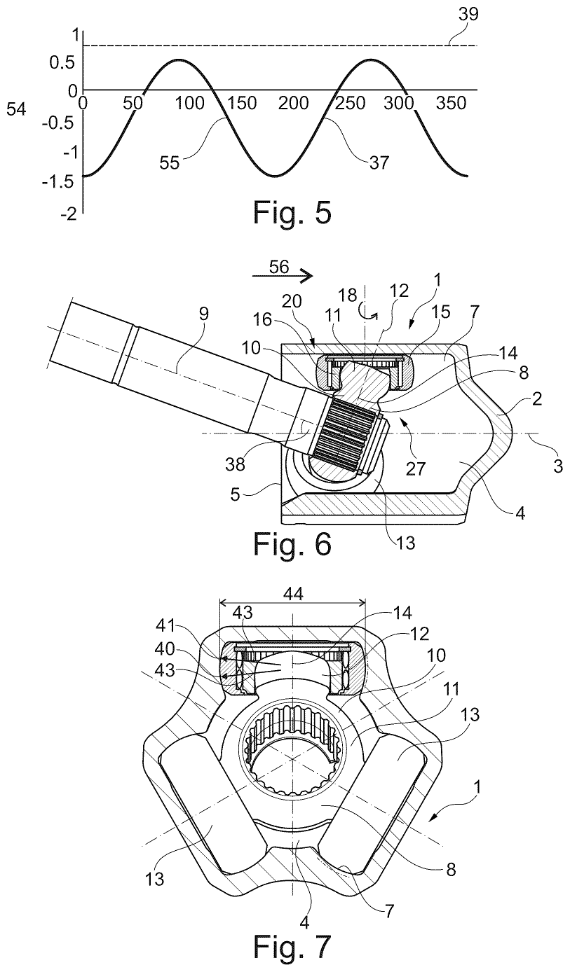

FIG. 5 shows a second diagram. The displacement 54 of a trunnion 11 in the radial direction 42 is plotted on the vertical axis (in millimeters). The angle of rotation 56 of the tripod joint 1 is plotted on the horizontal axis (from 0 to 360 angular degrees). Reference is made to the explanations for FIGS. 1 to 4.

The second course 55 shows the displacement 54 of the trunnion 11 and thus of the PCD1 37 as a function of the angle of rotation 56 when the tripod joint 1 is deflected by the deflection angle 38. The upper straight line shows the PCD2 39 of the outer joint part 2, which has a constant value.

A PCD2 39 (pitch circle diameter) of the outer joint part 2 is greater than a PCD1 37 of the inner joint part 8 (see FIG. 3) by a difference D, whereby the following applies to the difference D: D≥¼*PCD2*cos(1/α). α is the largest deflection angle 38 between the first longitudinal axis 3 and the second longitudinal axis 9 that occurs during the intended operation. This condition always applies during intended operation, i.e., at all times, meaning that the difference between PCD1 37 and PCD2 39 is selected such that PCD1 37 is always smaller than PCD2 39, even when the trunnion 11 is displaced by displacement 54 (see FIG. 5).

FIG. 6 shows the tripod joint 1 according to FIGS. 1 to 3 in a deflected state, in a side view in section. FIG. 7 shows the tripod joint 1 according to FIG. 5 in a view along the first longitudinal axis 3, in section. FIG. 8 shows the tripod joint 1 according to FIGS. 1 to 3 and 5 to 6 in a different deflected state, in a side view in section. FIG. 9 shows the tripod joint 1 according to FIG. 8 in a view along the first longitudinal axis 3, in section. FIGS. 6 to 9 are described together below. Reference is made to the explanations for FIGS. 1 to 5.

The tripod joint 1 is shown in a deflected state in each case. This means that there is a deflection angle 38 of approximately 20 angular degrees between the first longitudinal axis 3 and the second longitudinal axis 9. FIGS. 7 and 9 show that the inner ring 16 of the roller body 13 is displaced inwards along the axis of rotation 14 towards the second longitudinal axis 9 relative to the outer ring 15 and the rolling elements 17.

The inner ring 16 has a cut-out 28 on the second end face 27 that runs along the second circumferential direction 18. This cut-out 28 allows the inner ring 16 to be made wider in a direction 23, 26 along the axis of rotation 14. This ensures permanent contact between the sliding surfaces of the inner ring 16 and the trunnion 11. In addition, the cut-out 28 is designed in such a way that a projection on the outer ring 15 in the area of the second end face 27 of the roller body 13 is not contacted by the inner ring 16 despite the relative displacement 54 of the inner ring 16.

The outer ring 15 has a smallest first diameter 31 on the second end face 27, which is smaller than a second diameter 32 of the outer circumferential surface 29 of the inner ring 16 and larger than a smallest third diameter 33 of the cut-out 28.

The outer ring 15 has on the second end face 27 (of the roller body 13 or the outer ring 15) a third stop 34, which is effective with regard to the second direction 26 for the rolling elements 17 (in the receiving space 19), and a fourth stop 35, which is effective with regard to the second direction 26 for the inner ring 16. The fourth stop 35 is formed by the projection of the outer ring 15, which extends to the smallest first diameter 31.

The fourth stop 35 is spaced apart from the cut-out 28 along the second direction 26 at a distance Ds 36, where Ds 36 is defined as: Ds>¾*PCD1*cos(1/α). The PCD1 37 is the pitch circle diameter of the inner joint part 8 and α is the largest deflection angle 38 (see FIGS. 6 and 8) occurring in the intended operating range between the first longitudinal axis 3 and the second longitudinal axis 9.

The distance Ds 36 is the distance between the stop surfaces of the inner ring 16 and the outer ring 15 arranged opposite each other along the axis of rotation 14. The distance Ds 36 ensures that there is no contact between the inner ring 16 and the outer ring 15 during the intended operation (as shown in FIGS. 6 and 8).

The size of the distance Ds 36 is limited so that, during the intended operation, the outer ring 15 does not contact the inner joint part 8.

The third stop 34 and the fourth stop 35 are both formed by the outer ring 15 itself.

The tripod joint 1 is designed in such a way that, within an intended operating range (also referred to as intended use/operation) of the tripod joint 1, contact between the inner ring 16 and the outer ring 15 is prevented at a second end face 27 of the roller body 13 facing the second longitudinal axis 9 (see FIGS. 5 to 9). FIGS. 6 and 8 show that only the inner ring 16 contacts the central body 10.

1. A multipod joint with an outer joint part with a first longitudinal axis and a cavity running parallel to the first longitudinal axis with an open end, wherein at least two recesses extending parallel to the first longitudinal axis are distributed in the outer joint part along a first circumferential direction, which extends around the first longitudinal axis, and an inner joint part with a second longitudinal axis, comprising at least one central body to which at least two trunnions are formed with trunnion axes extending radially from the second longitudinal axis, wherein a roller body rotatable at least about the trunnion axis is arranged on each trunnion; wherein each roller body is movably received in one of the recesses along the first longitudinal axis; wherein each roller body has an axis of rotation, an outer ring, an inner ring arranged concentrically to the outer ring and concentric to the axis of rotation, and a plurality of rolling elements between the outer ring and the inner ring, which are arranged next to each other along a second circumferential direction in a receiving space extending along the second circumferential direction of the outer ring so that the inner ring can rotate relative to the outer ring about the axis of rotation; wherein the inner ring is displacable relative to the outer ring and the rolling elements along the axis of rotation; wherein the outer ring forms a first stop with the inner ring at a first end face of the roller body facing away from the second longitudinal axis, which first stop limits a first displacement path of the inner ring relative to the outer ring, wherein the first displacement path extends along a first direction parallel to the axis of rotation and away from the second longitudinal axis; wherein the inner ring forms a second stop with the trunnion, which limits a second displacement path of the inner ring relative to the trunnion, wherein the second displacement path extends along a second direction parallel to the axis of rotation and towards the second longitudinal axis; wherein the multipod joint is designed such that, in an intended operating range of the multipod joint contact between the inner ring and the outer ring is not possible at a second end face of the roller body facing the second longitudinal axis, or that only the inner ring contacts the central body.

2. The multipod joint according to claim 1, wherein the inner ring has, on the second end face, a cut-out extending circumferentially along the second circumferential direction, through which an outer circumferential surface of the inner ring contacting the rolling elements is shortened and an end face pointing toward the second longitudinal axis is reduced in size.

3. The multipod joint according to claim 1, wherein the outer ring has a smallest first diameter on the second end face which is smaller than a second diameter of the outer circumferential surface and larger than a smallest third diameter of the cut-out.

4. The multipod joint according to claim 1, wherein the outer ring on the second end face has a third stop that is effective for the rolling elements with regard to the second direction and a fourth stop that is effective for the inner ring with regard to the second direction; wherein, in an extended state of the tripod joint, the fourth stop is spaced apart along the second direction at a distance Ds from the first cut-out, wherein the following applies for Ds (36): Ds>¾*PCD1*cos(1/α) ; where PCD1 is the pitch circle diameter of the inner joint part and α is the largest deflection angle occurring in the intended operating range between the first longitudinal axis and the second longitudinal axis.

5. The multipod joint according to claim 4, wherein at least the third stop or the fourth stop is formed by the outer ring itself.

6. The multipod joint according to claim 1, wherein, in an extended state of the tripod joint, a PCD2 of the outer joint part is greater than a PCD1 of the inner joint part by a difference D, where the difference is given by: D≥¼*PCD1*cos(1/α); where α is the maximum deflection angle occurring in the intended operating range between the first longitudinal axis and the second longitudinal axis.

7. The multipod joint according to claim 1, wherein the outer ring has a toroidal outer shape and the outer ring contacts the recess at two contact points in each case, wherein the contact points are spaced apart from each other in a radial direction.

8. The multipod joint according to claim 7, wherein the toroidal outer shape satisfies the following condition: 0.5≤2*Rs/Dr≤1; where Rs is the radius of curvature of the toroidal outer shape in the region of the contact points and Dr is the largest diameter of the outer ring.

9. The multipod joint according to claim 1, wherein an intended operating range comprises a largest deflection angle occurring between the first longitudinal axis and the second longitudinal axis of between 12 and 20 angular degrees.

10. The multipod joint according to claim 1, wherein the first stop is formed by a retaining ring arranged on the outer ring.

11. The multipod joint according to claim 1, wherein the second stop is formed by a concavely curved or conically shaped first section of an inner circumferential surface of the inner ring, which adjoins along the first direction a cylindrically shaped second section of the inner circumferential surface, wherein a diameter of the inner circumferential surface in the first section is smaller than a diameter of the inner circumferential surface in the second section.

12. A roller body for a multipod joint according to claim 1, wherein the roller body has an axis of rotation, an outer ring, an inner ring arranged concentrically to the outer ring and to the axis of rotation, and a plurality of rolling elements between the outer ring and the inner ring, which are arranged next to each other along a second circumferential direction in a receiving space of the outer ring which extends circumferentially along the second circumferential direction, so that the inner ring can rotate relative to the outer ring about the axis of rotation; wherein the inner ring is displaceable relative to the outer ring and the rolling elements along the axis of rotation; wherein the outer ring forms, with the inner ring, at a first end face of the roller body facing away from the second longitudinal axis, a first stop which limits a first displacement path of the inner ring relative to the outer ring, wherein the first displacement path extends along a first direction parallel to the axis of rotation and away from the second longitudinal axis; wherein the inner ring has a concavely curved or conically shaped first section on an inner circumferential surface, which adjoins along the first direction a cylindrically shaped second section of the inner circumferential surface, wherein a diameter of the inner circumferential surface in the first section is smaller than a diameter of the inner circumferential surface in the second section; wherein the inner ring has, on the second end face has a cut-out extending circumferentially along the second circumferential direction, by means of which an outer circumferential surface of the inner ring contacting the rolling elements is shortened and an end face pointing toward the second longitudinal axis is reduced in size.

13. The roller body according to claim 12, wherein the outer ring has a smallest first diameter on the second end face which is smaller than a second diameter of the outer circumferential surface and larger than a smallest third diameter of the cut-out.

14. The roller body according to claim 12, wherein the outer ring has on the second end face a third stop which is effective for the rolling elements with regard to the second direction and a fourth stop which is effective for the inner ring with regard to the second direction.

15. The roller body according to claim 12, wherein at least the third stop or the fourth stop is formed by the outer ring itself.
